(19) United States
(12) Patent Application Publication
(10) Pub. No.: US 2005/0071359 A1
(43) Pub. Date: Mar. 31, 2005

(54) Method for automated database schema evolution

(76) Inventors: Deepak S. Elandassery, Napierville, IL (US); Brian Neil Mogensen, Lisle, IL (US); Kathleen Anne Perkins, Warrenville, IL (US)

Correspondence Address: DUANE MORRIS, LLP;IP DEPARTMENT, ONE LIBERTY PLACE, PHILADELPHIA, PA, 19103-7396, US

(21) Appl. No.: 10/670,947

(22) Filed: Sep. 25, 2003

(51) Int. Cl. G06F 17/00

(52) U.S. Cl. 707/102

(57) ABSTRACT

A database structure of a sort defined by an access and query language that defines tables of variables having labels and field characteristics, such as ANSI structured query language (SQL), is modified by determining the structural differences between an existing schema and a new schema, independent of database contents. The differences are processed to generate commands that are then applied to evolve an existing database from the old schema or structure to the new one. This avoids the need to dump and restructure the contents of the old database for reload into an empty new database that has been prepared to meet the new schema.

### BACKGROUND OF THE INVENTION

The invention relates to the manipulation of databases, especially the manipulation of potentially complex databases using structured query language (SQL) or other similar high level database-access command systems.

### PRIOR ART

A database is organized to contain stored data values for variables that have attributes and are related to other variables. For example, variable attributes may dictate legal values of distinct data types such as strings versus integers, predetermined byte lengths or limits on legal values. The labels are chosen and the attributes are assigned in view of the information that the values represent. For example, names might be defined as variable length strings up to some maximum length. The applicable label for name might help to identify a category, e.g., customer_name versus employee_name. A natural person might be identified by a name and also a number such as an employee number or Social Security number. Social Security numbers always have nine decimal digits, etc. Such labels and attributes are part of the database organization.

Additionally, the variables and values are related to each other according to relationships that may entail imposing other attributes or requirements, so that selecting for values of a given variables will permit meaningful selection of other values that are related to the selected value. For example, if the key to a database of information about persons is to be the value entered for each person's name, then a name must be entered for each person, and the name value must be unique. On the other hand, one might use a serial number as the element that is to be unique, in which case it is possible to distinguish between two people with the same name or to handle a record when a person's name is not known.

The labels, attributes, requirements and relationships between variables are aspects of the organization of the database that are encoded as the database structure or schema. The database structure is independent of the values stored under particular variable names. The structure is also independent of what information the variables represent to the database user, even though users depend on the structure, for example relying on the uniqueness of key variables if such uniqueness is built into the database schema.

A simple database can have a two dimensional table of values. A more complex database could have plural tables, many dimensions and various key variables that are employed to relate the data values to one another. Preferably the arrangement facilitates searches and selections as needed to support the operation of the owner's business. Often, the database is a collection of values from different sources, and the database is organized by the manner in which the data is manipulated as opposed to preplanning or regimentation of the particular fields that are to maintained and related to one another.

Useful database tables need not be inherently structured to a great degree because the commands used to access the database impose structure in a sense. Commands such as SELECT <variable label><criteria> permit the user to employ the results of the selection of entries in tables, which then become defined variables that can function as variables in user-defined tables.

Programmers and users rely on understandings as to what the variable values in the fields are expected to represent, and also on data criteria that are embodied in the database structure, such as limits on legal values, uniqueness and the like. The user also relies on the data types or formats and conditions on legal/illegal values under each variable name or label (which may possibly include aliases and alternatives). In a business having numerous functions, such as manufacturing, sales, human resources, etc., there may be a number of different operations that access portions of a large store of data, for their own purposes. As the business evolves, new capabilities can be added. New relationships among data values can be exploited to generate statistics, reports, to produce new fields with values based on the initial values, to facilitate extensions of operations and the like.

The stored values have attributes and the variables that the values represent have relationships. The attributes and relationships may be needed in order to enable manipulation of the database in certain ways. An example is uniqueness. Relationships between entries and values may or may not need to be unique depending on whether or not a variable is to be used as a key to join tables. For example, in a database related to persons, it may be required that every person represented in the database have a unique stored name and ID number in at least one of the tables. On the other hand, two or more persons might have the same first or last name, the same birth date, etc.

Data attributes may be imposed on values. For variables having values that are formatted and stored so as to contain a maximum number of bytes, maximum size or value limits may be needed to prevent overflow or truncation. For values that are to be subjected to numerical manipulation such as averaging, all the fields must be numeric rather than alphanumeric, in order to have valid results. These attributes can be imposed using the programming language by which a database is defined and accessed.

The capabilities of a database may expand. Adding new information or points of access may open the possibility of exploiting the data in new ways. A programmer may discover a new use for the data. Thus, the database evolves over time. Various persons and groups may use the information in the tables to carry on business, using application programs that typically serve a primary function but also build a store of information. The information may affect the functions of other persons and groups.

Structured query language (“SQL”) is an ANSI standard computer language for accessing and manipulating databases. Among its standardized commands are commands that define data types and field sizes, assign variable names, and similarly allow sets of tables to be established and related. The tables need not correspond by rows and/or columns, but nevertheless are useful because the data in the tables can be joined through one or more variables that are related. The SQL commands thus permit one or more tables to be established for storing data having some sort of significance, and thereafter organize the data into one or more useful collections or databases, relying on the same set of tables, having different arrangements by which the data and the tables are used.

Database structures and tables, as well as the software programs that access the database change or evolve over time. There are different reasons for this. There may be changes in the operation that the database seeks to represent, such as new categories of data that arise and provide new uses for the database. The number of possible values of a given variable may change. A new technique may become available and advantageously require a change in the database design specifications, imposing new requirements on legal versus illegal values. Thus, even if a database is very efficiently configured and designed, over time the database organization or schema may need to change. In this context, the database schema encompasses all the structural aspects and logical relationships that are entailed in the database, apart from the variable data value content that also changes and often grows while conforming to an established schema.

Changing a database schema carries risks and at least produces added requirements that might be categorized as data or data storage translation operations (e.g., if some aspect of the data is to be changed), software conversion requirements (such as updating application programs for operation under the new schema), maintenance and integrity checking duties (to ensure that applications programs still operate as intended) under the new database schema). It is difficult to anticipate all the ways in which a change may defeat the truth of some assumption that an application program or user relies upon, and where even a seemingly minor change may render an application inoperable.

U.S. Pat. No. 6,487,558—Hitchcock teaches a technique for generating documentation from an automated analysis of a server database and also the user databases that are defined by instructions that the users employ to access and manipulate data found on the server. This technique can produce human-readable documentation, and can produce scripts that can be executed to recreate a database. The procedure is periodically to analyze the database and to store attribute information over the broad system database and over a variety of user databases derived from the system by means of operator commands.

U.S. Pat. No. 6,356,901—MacLeod et al. teaches a technique for importing and/or exporting database contents through a transform whereby the data is formatted for reception in the destination database. The user specifies the particulars of the destination database. The transform through which the data is fed, attaches lineage information associated with the origin database.

U.S. Pat. No. 5,797,137—Golshani et al. teaches an automated method to convert a database from a relational schema to an object oriented schema. The conversion discussed concerns defining associations between variables and generating tables by selecting records having a particular association. In the example of a database having a table for students and a table for class offerings of an academic department, the association of students with a particular class offering results in an attendance list or table of students enrolled in the class.

U.S. Pat. No. 5,950,188—Wildermuth teaches a database interface in which users can apply SQL commands to stored tables and indices. Additionally, the server contains an interface engine that parses and reduces user SQL commands for application to the stored information, generating system level SQL commands in the process. Thus the engine in the server operates in a manner that is partly analogous to operation of a user of its own tables.

The foregoing patents, which are incorporated for their disclosures of SQL data structures and commands, lack the aspect of database evolution. It is a problem in maintenance and operation of databases that users seek over time to exploit newly discovered capabilities, to add fields, to define new associations, and to revise the previous database definitions. Any given user or database manager is unlikely to know or fully appreciate all of the aspects of a database that users presently rely upon or may wish to rely upon later. Therefore, changes to the organization of a database, including establishing relationships, imposing conditions, formatting particulars and the like, can have unintended consequences and are not undertaken lightly. Database managers may have rules that prohibit changes to database variables until proposed changes are published to other users and approved. This is an unwieldy process, and there is a tendency for users to resist beneficial changes because any change carries some risk. A more dependable technique to make evolutionary database structural changes would be advantageous if the risk was reduced that changes would carry unintended adverse consequences.

Apart from assumptions that may become invalid if a database structure is changed, some information that is maintained in databases is index information that is generated when a database is operationally established. The index contains shortcut information to expedite the ability to access related data values by reducing the need to search through all values when a generated value is needed, such as a count or average or the like. An index may be generated to assist in finding data quickly, such as to mark the boundaries of tables. The index needs to be generated. When a database configuration or schema changes, the data from the old database needs to be read from the old configuration, changed, and written into the new configuration, and new indices are needed.

Conventionally, when databases are upgraded or changed, a separate routine is needed as a part of installation of the upgrade. This routine is needed to read, change and re-write the changed contents of the old database so as to comply with particulars of the new schema. This is often done by writing a customized routine, for example, in C or C++, to effect the conversion.

In that case, a developer may code the modifications to the header and source files that identify and embody the new database structure or schema. This source code (e.g., in C or C++) is compiled and run to create an operational database according to the new schema. The data contents of the old database is copied or laid out in an organized way, for example being dumped into a flat text file. This text file is modified by the conversion/translation program to change the data layout and data values (where necessary) from the old schema to the new one. The change could involve, for example, adding new data fields, reformatting the values in existing fields by allotting more or fewer bytes or by changing the formatted data type, and perhaps changing the data values in the process. This causes the text file to assume the attributes of the new database structure. Finally, the modified data is loaded into the new database.

The developer that codes the C or C++ routine to dump, transform and reload the data can be expected to make various assumptions about the character of the data. For example, if the developer observes data values in the origin database to have a particular characteristic of data type or the like, that characteristic may be regarded, erroneously, as a restriction or condition. The developer may erroneously build the restriction into the rewritten database. Similarly, the database may have a restriction on values that the developer does not appreciate and erroneously fails to carry forward, generating new errors or rendering certain applications programs functions inoperable. On the other hand, even if no such condition is observed or assumed, it would be advantageous if a technique could allow a user who wishes to impose a new restriction of database structure to do so, provided that the change can be accomplished without interfering with other database operations or with the assumptions of other users.

One way to reduce the risk of problems when making changes to any software is to save the old version and revert to it if problems arise. That method is not entirely useful in databases wherein new data is added on a regular basis. Although some testing is possible and is certainly advantageous, the time comes when it is necessary to change over to the revised database structure because to delay making the change may suspend the addition of new data when a database schema is changed. There is a possibility of maintaining tables in which some of the fields contain before and after data that is different as a result of database schema versioning. In versioning techniques, a version control mechanism may be provided to enable simultaneous handling of data according to two or more distinct versions. This method of dealing with changes is obviously complicated and can produce problems of its own. In order to directly compare comparable fields across the occurrence of a version change, either the old or new version data needs to be operated upon or specially handled to account for the change.

Versioning has the benefit of not requiring permanent and irreversible changes to the old data. There is no guarantee, however, that if difficult conversion problems appear and are discovered either immediately or long after making a schema change, that the best way to correct the problems will be to revert to the old version. Furthermore, such problems and the user's ability to discover them may be hidden by complications associated with supporting plural versions.

It would be advantageous to provide a technique that can determine reliably the particular changes, and all the changes, needed to convert a database structure from one structure or schema to another. It would further be advantageous not to rely on a programmer to find and to understand and accurately to effect all the changes needed. Preferably, such a technique would be automated and thus safe from various sorts of human errors. One advantage of improving the reliability of the conversion operation is that there is less work, inconvenience and insecurity associated with application that use the database and may require corresponding changes or may become inoperable in unpredictable ways.

### SUMMARY OF THE INVENTION

An inventive automated technique facilitates changes to the structure of a database, by generating a series of database instructions that effect the changes. A pre-existing database structure or schema is compared to an intended or target structure or schema. The differences are used to generate a set of conversion commands that can be applied to a database organized according to the old schema in order to convert or evolve the database so as to comply with the new schema. The process has minimal impact on the database contents, although changes in data type formatting and field labels are possible, and tables or fields can be generated or eliminated if desired. Automation of the conversion reduces risk of damage to the data contents of the database as well as to operation of applications programs that use the database. Because there is little or no reliance on customized conversion programs, there is reduced danger of damage as compare to a situation in which a developer might not recognize or fully appreciate a data restriction or attribute that is contained in one of the old and new schemas, and/or the full implications of changing it.

It is an aspect of the invention that instructions to convert data from a pre-existing database structure to a new structure are automated, generated from database definitions apart from database contents, and used to produce a set of automated commands to alter the original database structure.

The invention permits a conversion that is free of quirks and errors that could be produced by relying on human assessment and planning of changes needed to convert between database structures.

According to the invention, changes between database schema are defined and the differences embodied by automatically generated instructions using a high level language. This reduces the effort, expense and risk associated with a change in database structures, namely to write, inspect, test and operate a routine to effect a schema change.

In a preferred arrangement standardized data attributes, especially as determined by ANSI structured query language (SQL), enable commands to be parsed into operative numeric values and strings defining arguments that are interpreted as data characteristics, variable relationships and limitations such as legal/illegal values, correspondences, uniqueness requirements and the like. The SQL commands are analyzed in a programmed sequence to extract the field conditions and variable relationships that define the starting database schema. The new schema is similarly analyzed and compared to the original schema. Any change in the schema, such as different data conditions and relationships, are noted. This comparison is accomplished in a standardized manner and used to generate a conversion whereby the original database defined by sets of SQL commands is altered to assume the new schema, with only limited capability for the operator to alter the arrangements inconsistently or in a manner that unpredictably interferes with operation of an application.

These and other aspects are provided by the invention for modifying a database structure of the sort defined by an access and query language that defines tables of variables having labels and field characteristics, such as ANSI structured query language (SQL). The database is modified by determining the structural differences between an existing schema and a new schema, independent of database contents. The differences are processed to generate commands that are then applied to evolve an existing database from the old schema or structure to the new one. This approach avoids the need to dump and restructure the contents of the old database for reload into an empty new database that has been prepared to meet the new schema. The approach insulates the change from assumptions that a developer might make about the data contents in writing a conversion program to effect conventional restructuring as described.

The database is defined at least partly by commands that define a database schema containing tables with fields that have attributes. The process includes providing a set of schema instructions defining a database structure according to a preexisting schema, and a corresponding set of schema instructions defining the database according to the new or modified schema. The two sets of schema instructions are parsed to build two logical syntax trees representing structure types and attributes that may differ. The comparison of the old schema to the new schema is accomplished without reference to the data contents. Assumptions based on the data contents cannot arise to affect the conversion.

The comparison of old/new schema can involve a line by line comparison of SQL commands in which differences are readily identified by additions, deletions and value changes between SQL instruction sequences that are otherwise similar. Parsing into syntax trees enables a comparison that is at least somewhat independent of the order of the SQL commands.

Detected differences are processed to produce database modification commands that can then be applied to the database according to the preexisting schema. The result is a database according to the modified schema, corrected and operational according to the revised structure types and attributes.

### BRIEF DESCRIPTION OF THE DRAWINGS

The foregoing features and advantages of the invention, as well as other aspects and routine extensions of the invention, are apparent from the following detailed description of examples and preferred embodiments, to be considered together with the accompanying drawings, wherein the same reference numbers have been used throughout to refer to the same functioning parts, and wherein:

FIG. 1 is a data flow diagram illustrating the data structures, communication paths and processing operations according to the invention.

FIG. 2 is a tabular comparison of simplified exemplary database schema arrangements, showing an exemplary schema change.

FIG. 3 is a data flow diagram showing the Schema Differ determination aspects of the invention in greater detail.

FIG. 4 is a schematic block diagram showing a programmed system, in particular a network coupled to a database server, and a data carrier for containing programming according to the invention.

### DETAILED DESCRIPTION OF THE PREFERRED EMBODIMENTS

A number of exemplary embodiments of the invention are described herein with reference to the drawings. These embodiments are examples intended to demonstrate aspects of the invention in different forms or separately. Not all these aspects are required in every embodiment of the invention, and the illustrated embodiments should be regarded as exemplary rather than limiting.

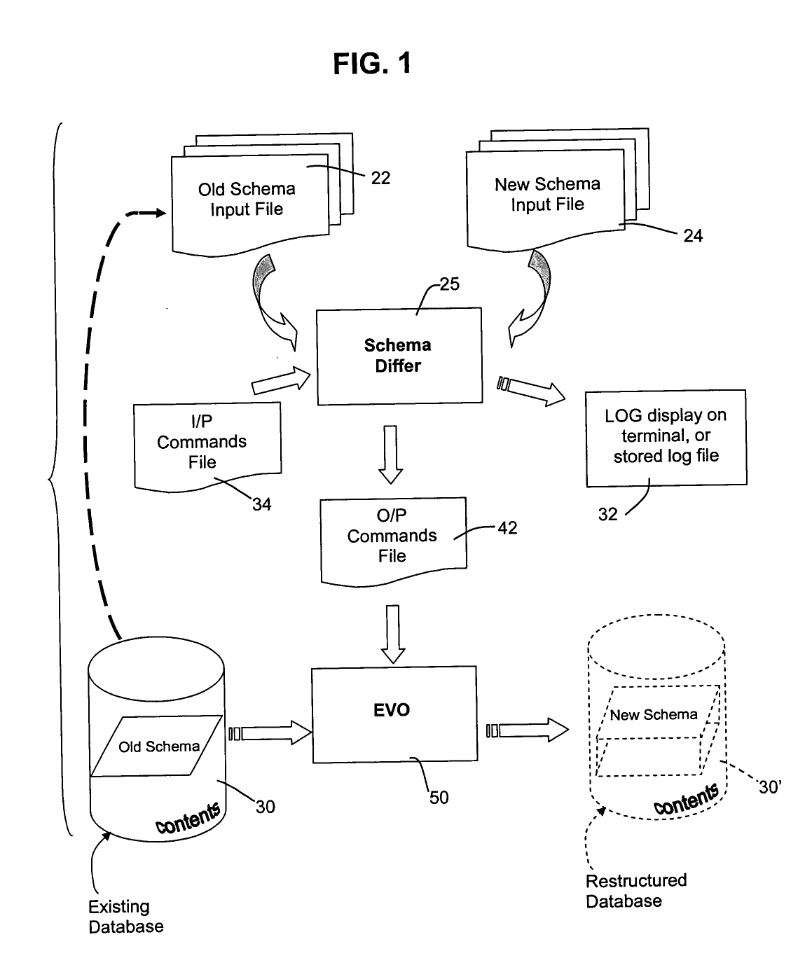

Referring to FIG. 1, the invention provides a technique to compare two different database schemas 22, 24 embodied in instructions, such as structured query language (SQL) statements, by which the contents of a database 30 can be defined with respect to certain requirements, labels and relationships among variables and the like. Such attributes are generally termed the database “structure” in this description, and are subject to definition independently of the actual values that are stored in the database. The schema that defines an existing database 30 can be distilled into its set of instructions 22. These instructions define the “old” or preexisting database schema.

The structure of the database 30 is to be changed for some reason, such as to add to the capabilities of the database, for example. Therefore, a new set of schema instructions 24 have been composed to define the structure of a new database that is to employ some or all of the content of the old database 30. It is not possible simply to invoke the new schema instructions on the existing data content, because the manner in which the content has been defined, stored and/or organized is compliant with old schema instructions 22 but not necessarily with the new instructions 24. Various differences that may exist include the manner in which the data values are encoded, how many bytes are used to store values, whether there are limitations on values such as maximum or minimum limits requirements of uniqueness, null-ability and similar constraints.

It would normally be necessary when changing from one schema definition 22 to another 24, to plan out a new database 30′ conforming to the new schema instructions 24; to copy (dump into a file or otherwise access) the contents of the existing database 30; to alter the existing contents so as to comport with the new database schema; and finally to load the altered contents into the new database 30′. According to an aspect of the invention, that procedure is automated and supplanted by a programmed technique to determine changes needed, based on a substantially-automated analysis of the old and new schema instruction sets 22, 24, and to generate, again substantially automatically, instructions that make all necessary changes to the content at or about the same time that the new schema instructions 24 are made operative. In this way, the user need not understand and account for all the implications of all changes that are made when changing from one schema to another. On the contrary, the technique insulates the database evolution from one schema to another by making the evolution independent of user interpretations as to the respective old and new database schema, i.e., variable definitions, limitations, relationships and other aspects of database structure.

The two database schemas 22, 24 are expressed as sets of SQL commands that define table structures, the nature of the values populating fields in the databases and similar aspects of database 30. The two database schemas are described herein as the pre-existing (before) and target (after) schemas or structures. The database schemas can concern an entire database store, or the tables to be evolved can be selected subsets of data stored in an establishment's SQL server(s). Thus, it is possible that the invention could be used to carve a new database schema according to input file 24 from the previous database according to file 22, and thereafter to have two coexisting schema arrangements using their own versions of the content and/or the same data store, as needed.

The technique of the invention employs a database schema evolution tool or procedure. This tool includes a Schema Differ process 25 that compares the two SQL files 22, 24 defining database structures, and generates a set of commands used by another process to operate on database 30, namely a database that was previously defined by the SQL commands in the first file 22. The end result is a database 30′ having a structure that matches the SQL commands in the second file 24 and contains the data needed from the old database 30.

Insofar as possible, the data contents or values in the file should not change by operation of the tool, shown generally in FIG. 1, although changes are possible. The changes that can be effected without interfering with data values include changes of formatting and variable association and the like. It is possible to operate on the original contents to produce new values such as to add an offset or perhaps to convert a variable from one measurement system to another, to insert default values if necessary, etc. It is also possible that changes to the schema will produce errors and exceptions that did not exist before. According to the invention, such problems are less serious than would occur in the case of a custom coded program wherein the author is required to understand and account for all the implications of a change in data structures.

In one embodiment, the tool is interactive, providing data using a LOG display 32 that can be stored for reference or presented on a user terminal (not shown in FIG. 1). The tool also accepts instructions from a user managing a database structure conversion, via an input commands file 34, which can be derived from user inputs and responses to invitations, prompts and generated data reports to the operator via LOG display or file 32. The user input can be made, for example, by placing a command input into commands file 34 when a selection is required among possible alternatives indicated according to LOG 32. The input can be provided in an input language specific for the tool, or such selections can be input via pull-down menus, CGI boxes and similar known user interface techniques.

The prompts can be made more or less extensive depending on the complexity of the database and the level of expertise expected of the operator. An extensive set of prompts can be used to present or display to the operator most or all of the characteristics of the databases (old and new) together with highlighting of the full set of structural changes that the tool has detected by comparing the old and new schema definitions. This information may be helpful for the user to appreciate the changes that are to be effected and their consequences. Conceivably, the user can reconsider and modify changes at this stage. Alternatively, the prompts can simply present to the user choices that remain to be made in composing the new schema definition when choices arise as to details that have not been specified.

Examples of changes to a database structure that are apt to be made using the database schema conversion tools of the invention include, at least: the addition of new tables; the deletion of existing tables; renaming of existing tables or renaming of fields in existing tables; addition or deletion of fields in the existing tables; changes to the data type or formatted structure of existing fields; insertion of fields based on existing values; changes to values; application of new conditions to fields or removal of previous conditions; and similar changes.

As shown in FIG. 1, evolution from database 30 according to schema definitions 22, to database 30′ according to definitions 24, begins with operation Schema Differ procedure 25, which compares the contents of an Old Schema Input file 2 and New Schema Input file 24. These two Schema input files 22, 24 contain a series of SQL statements that describe the data layout of a database before and after a planned evolution. It is necessary for Schema Differ process 25 to interpret the structures that are defined and to compare such structures so as to provide a complete representation of the differences.

The SQL statements defining the respective before-evolution and after-evolution data layouts might be more similar or less similar in a given case. The order of different sections could be the much the same or could be quite different. In a situation in which the evolution is directed to changing a relatively isolated aspect of a database, the before- and after- versions may be similar except for changes to individual parameters associated with the isolated aspect to be changed. For example, the Old Schema and New Schema may have a number of SQL statements that are the same and appear in the same sequence. Some statements may differ as to their associated arguments or modifiers. Other portions may contain statements to introduce, delete or change more substantial database structures, such as to introduce new tables or defining new keys. Some changes, for example the order of statements in a case where the order is non-critical, preferably are ignored.

The Schema Differ process 25 takes the old and new Schema Input files 22, 24 and preferably also accepts input 34 from operator selections that are presented in the event of certain ambiguities. Due to operator selections and directions, or independently, the Schema Differ process 25 can be permitted to perform auxiliary operations. However, the Schema Differ process relies on the database-defining commands, without reference to the contents of the variable fields.

The Schema Differ process 25 produces a display log or a log file 32 that shows the differences that were found between the Old and New Schema input files 22, 24. This log is helpful to advise the user as to the particular changes that are made and perhaps to point out unplanned differences that might result in errors. The Schema Differ process 25 also produces a file 42 containing a set of output commands than are fed into a database evolver process, namely EVO 50, that actually alters the database 30 and produces evolved database 30′.

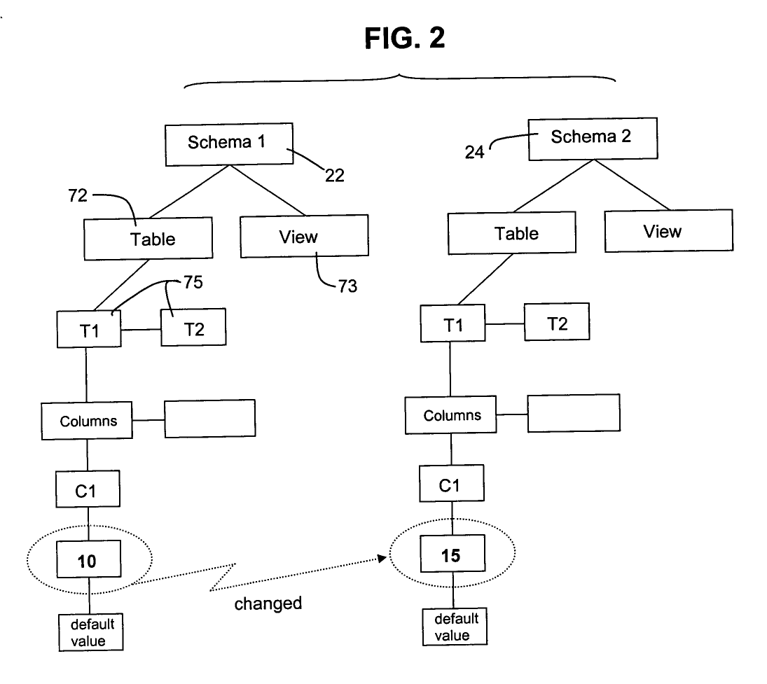

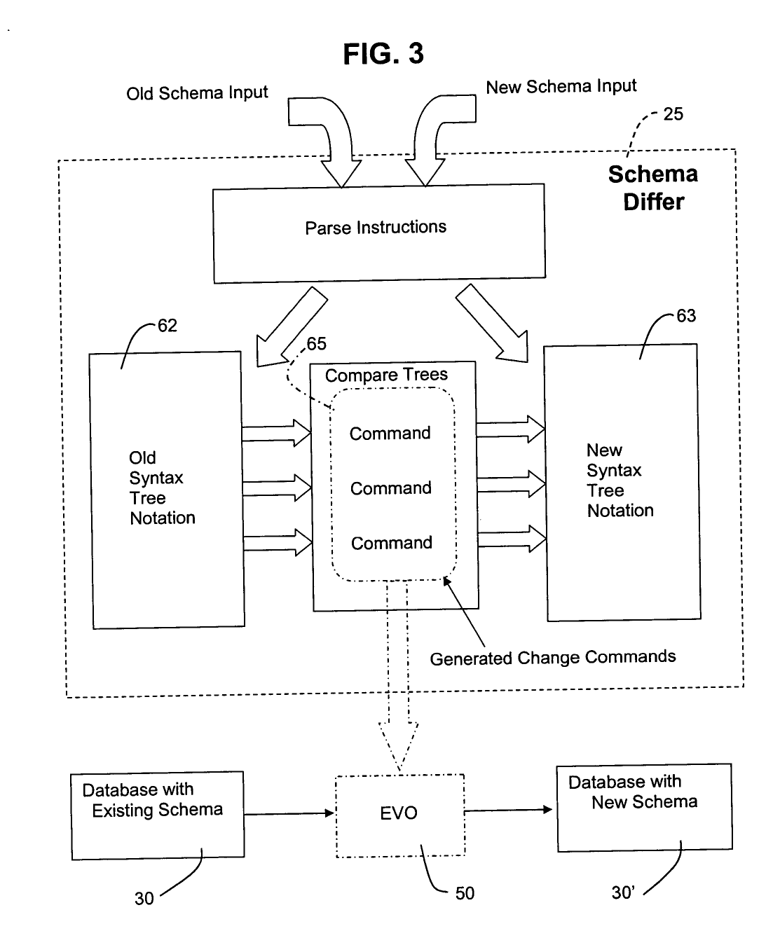

The Schema Differ 25 parses the Old and New Schema input files to develop two abstract syntax tree notations, for examples as shown graphically in FIG. 2. Although shown as graphic trees (which may be a helpful presentation to the user) the attributes are actually logical attributes that are reduced to selections of a finite set of alternatives for each parsed schema command, such as choices among a set of alternatives or specification of some value that defines an attribute. As shown in FIG. 3, parsing the instructions provides two syntax tree notations 62, 63, that can be compared, line by line, the differences including additions, deletions and changes begin used to generate change commands 65.

The SQL instructions can be parsed in the same manner as employed by a compiler or interpreter, such as by string searches in each command line to find terms between string dividers (e.g., spaces) according to the defined format for commands. The parsed command segments or terms can typically include one or more standard command terms from a set of possible command terms, one or more variable labels to which the command is applied, one or more numeric or alphanumeric arguments, one or more constant values, punctuation used for modification such as nesting of variable names or indexing, etc. The parsed command terms are compared to the library of possible SQL commands. Each command has a standard defined layout for command terms, labels and arguments, which are interpreted as such by the Schema Differ operation.

Typically, the SQL statements in the Old and New Schema input files 22, 24 vary by additions made in the New Schema input between lines of the Old Schema input, deletions where Old lines have been dropped, and modifications to labels and arguments where a command line appears both in the Old and New Schema inputs. By comparing the Old and New Schema, it is possible to identify specifically where the differences lie.

Referring to FIG. 2, a Schema may entail a set of Tables 72 and Views 73. Under Tables 72, the old Schema defined by instructions 22 (Schema 1) can have sub-tables 75 that have associated attributes. In the example shown, a table T1 is defined as having a variable or column C1 with an attribute 10, for example a maximum string size for an alphanumeric value. The new Schema defined by instructions 24 (Schema 2) is similar in this illustration, except that the C1 attribute is now 15. This is the only change in this illustration, but any number of changes could be involved.

The Schema Differ 25 produces as an output a set of commands 42, also shown in FIG. 3, which will be used to govern alteration of database 30 according to Schema 1 to render database 30′, containing at least a subset of the same data but being structured according to Schema 2 in FIG. 2. The commands file 42 is an alternate representation of the differences detected in the abstract syntax trees in FIG. 2. The commands are used as drivers for process EVO 50, the schema evolver, which structurally modifies the database 30 and its schema, while retaining the contents.

The Schema Differ process 25, having parsed both schemas into two abstract syntax tree notations (FIG. 2), proceeds through the tree for the old schema 22, comparing at each step the contents of the tree for the new schema 24 as determined in this notation. If any change is found, the difference is recorded in the Log file 32 and entries are made in output command file 42 to make changes. While this process is undertaken, it is also possible to conduct various other error checks. For example, the new schema can be checked for proper command semantics. The variable names and arguments can be checked for legal values, duplicate labels can be found and pointed out to the user as potential errors to be confirmed or corrected, etc.

Inasmuch as Schema Differ 25 begins by interpreting the instructions in the schema files 22, 24 to generate abstract tree representations of the instructions, aspects of the instructions 22, 24 that a human might find confusing, such as idiosyncratic differences in coding or the ordering of commands, choice of labels and the like, are made transparent. The actual comparison is made between the pertinent parameters and values that result from compilation or interpretation of the instructions, as opposed to a comparison of the instructions per se.

Some examples of structural changes that can be determined as described and then effected by application of database commands are:
add new table;
rename table;
add attributes;
rename attribute
change attribute type;
change attribute length;
change attribute null-ability;
add/change default value (the old value may remain in existing tuples);
change primary index.

Of the foregoing list, only “rename table” and “rename attribute” need to be include in the input commands file. The rest of the changes can be detected by the schema evolution tool EVO.

Behavioral changes are carried by triggers defined within the schema. That is, the schema may define an action to be invoked or triggered whenever a certain database event occurs. Depending on the database implementation, such triggers may need to be dropped before the schema is evolved, and established anew after the evolution. Triggers defined in a database table might respond, for example, to a particular change in data value. The trigger code may contain an attribute name or otherwise may need to be evolved, if there is a possibility that the evolution of the schema has changed database structural features applicable to the trigger. The triggers can be dropped and recreated after database evolution.

The abstract syntax tree preferably represents tables and other views representing the schema without regard to the order in which the schema instructions appear that define such tables and the like. Thus the comparison of Schema 1 and Schema 2 in FIG. 2 may require stepping through one of the trees (e.g., Schema 1) and at each step searching for a table, sub-table, attribute, etc. in the other tree, having the same or nearly the same attributes and labels as one in the other tree (Schema 2). It is possible that comparison of the trees in this manner can produce alternatives. The Schema Differ process can deal with alternatives in several ways. Extensive analysis can be used to determine a closest match between the New Schema and the Old Schema according to a preference or default condition without user input. For example, the process can “prefer” to make revisions to existing tables by making attribute changes identified by a comparison, over an alternative that might require deleting an old table and inserting a new table. As a different method, prompts to the user can be provided, inviting the user to select between such alternatives.

A change that the user might regard as a table to be added, for example, could have a variable in common with a table that is to be deleted. This raises an issue as to whether the change is to be handled as a deletion and addition of tables or alteration of a table. The end result may be similar or even identical. Similarly, deletion of a table and addition of a table may not be distinct from a change wherein a table and its included variables all are to be renamed. The method of presenting these options to the operator via display of the LOG file 32, and accepting the user's decision by way of the I/P commands input from the user, helps to effect the evolution process according to the user's control and expectations.

In the case of such as change, input commands are entered by the user to indicate the selection needed or to force the Schema Differ into one alternative or the other. For example, a command such as “TBL_NM_CHG <test1> <test2>” indicates that the table name is to be changed from <test1> to <test2>. The command “FLD_NM_CHG <test1> <fld1> <fld2>” changes the attribute name of <fld1> in table <test1> to <fld2>. These selections by the user can be incorporated in the output commands that are then provided to the evolver EVO 50, which effects the changes on the database after the process of evolution has been completed.

The output commands presented to evolver EVO 50 actually cause the changes to be made to the database schema. The Schema Differ 25 produces a file that is the main input to the EVO 50, for example a simple flat text file. Exemplary commands in the file are similar to the user selections discussed previously, having command names that refer to command operations, plus label names and arguments. These commands are likewise parsed by the evolver EVO 50 and applied to the preexisting database 30.

Without limitation, exemplary commands can include:

EXEMPLARY OUTPUT COMMANDS

| | | | | |
|---|---|---|---|---|
| TBL_NM_CHG | <test1> | <test2> | | changes name of |
| | | | | table <test1> |
| | | | | to <test2> |
| DROP_TBL | <test2> | | | eliminates table |
| | | | | <test2> |
| TBL_ADD | <test1> | | | adds a table |
| | | | | <test1> |
| FLD_NM_CHG | <test1> | <fld1> | <fld2> | changes attribute |
| | | | | name <fld1> in |
| | | | | table <test1> |
| | | | | to <fld2> |
| FLD_ADD | <test1> | <fld5> | | adds an attribute |
| | | | | <fld5> |
| | | | | to table <test1> |
| FLD_DROP | <test1> | <fld5> | | deletes an attrib- |
| | | | | ute <fld5> |
| | | | | from table |
| | | | | <test1> |
| FLD_SIZE_CHG | <test1> | <fld1> | 15 | changes the |
| | | | | field size |
| | | | | of attribute |
| | | | | <fld1> in table |
| | | | | <test1> to 15 |
| FLD_NULL_CHG | <test1> | <fld1> | null | toggles the null- |
| | | | | ability of attribute |
| | | | | <fld1> in table |
| | | | | <table1> |
| FLD_DFLT_CHG | <test1> | <fld1> | <defvalue> | changes the |
| | | | | default value |
| | | | | of attribute |
| | | | | <fld1> in table |
| | | | | <test1> to |
| | | | | <defvalue> |
| FLD_TYPE_CHG | <test1> | <fld1> | <XX> | changes the data |
| | | | <YY> | type of attribute |
| | | | | <fld1> in table |
| | | | | <test1> from |
| | | | | XX to YY |

Whether or not the commands are extensive depends on the extent to which the new schema differs from the old schema. However even in the event of relatively severe changes, the coding that is needed from the user is modest as compared to what might be required to produce a database dump such as a flat print-to-file text dump in the old schema, to alter the flat file to make the required changes, and to reload the database contents as the new schema. Moreover, by automating the process, the evolution is substantially insulated from user errors caused by less than complete understanding of the old and/or new schema structures, and failure to appreciate the full implications of changes.

The commands in the output from the Schema Differ process 25 are provided to the evolver EVO 50, which accomplishes the data-level evolution of the schema, making the changes without direct involvement by the user, for example by calling a routine ALTER TABLE to effect the changes according to the O/P commands produced by Schema Differ 25 and any defaults and the like that may be built into EVO 50. In particular, EVO 50 reads the output command file and encounters the commands sequentially. EVO calls appropriate functions depending on the keyword from the output command, passing the arguments along so that the changes are made on the targeted tables, attributes, etc.

The EVO function is closely associated with the Schema Differ function, but is preferably supplied as a separate routine so that EVO can be standardized on the front end and caused to produce an output that is customized to work with the particular database engine. The EVO calls are for general purpose functions and are abstracted from the lower level database specific commands. In the example shown in FIG. 2, the field size of attribute C1 in table T1 was changed. The command to EVO is “FLD_SIZE_CHG T1 C1 15.” Upon finding this output command, EVO calls the corresponding member function in the database engine to provide for a table that has been change as to the space used for attribute C1 from its previous value (“10” in the example shown in FIG. 2) to “15.”

This change can be made while the data is present in the table T1. Inasmuch as the previously existing data obviously could not exceed the field size that was formerly defined, increasing the field size operates to permit longer strings or larger integers to be stored in new values that may later be placed under the affected attribute. In the case of decreasing field size, it is possible to permit the user to select among alternative ways to reduce the size used. The user might be invited to choose, for example, to truncate strings on one side or the other. A process could be invoked to make space, for example to parse the data values and remove extra spaces, or even to replace certain terms with abbreviations before truncating.

It is possible to provide default conditions and values for the old data when an evolution occurs as described. For example, the default condition might be to left-justify string values and to insert trailing spaces as the default. Alternatively, the field size change can refer to the maximum length of a variable field size string. Such options can be handled by providing an output command for each possibility or an argument, and selecting among the possibilities by default or by presenting the user with choices to be made. As discussed, the choices are presented to the user via the LOG display on the user's terminal or stored in a LOG file, and the user's selections are input from the I/P Commands file, e.g., loaded from keyboard input from the user.

An advantage of automating database evolution as described herein is that the data is modified at the same time and in the same process as used when making structural changes to the database. The alternative would be to provide an empty database according to the new schema, to generate a dump of the database according to the old schema, to modify the dumped data to comply with the new schema, and to reload the modified data into the previously empty new database. According to the invention, various necessary changes such as tables to be included or removed, variable and variable name additions, deletions and renames, variable formatting changes, new conditions, etc., are automatic.

Another advantage of the invention is that the process of determining the necessary changes and the process of defining the commands that make them, up to the point that EVO 50 calls the ALTER TABLE routine, are separated from the data forming the contents of the database 30. Therefore, the schema changes are database independent. If portions of a database evolution need to depend on database values, then according to the invention, such changes that are peculiar to database values can be encapsulated and handled in a manner that is more convenient and safe than attempting a data dependent change in one process.

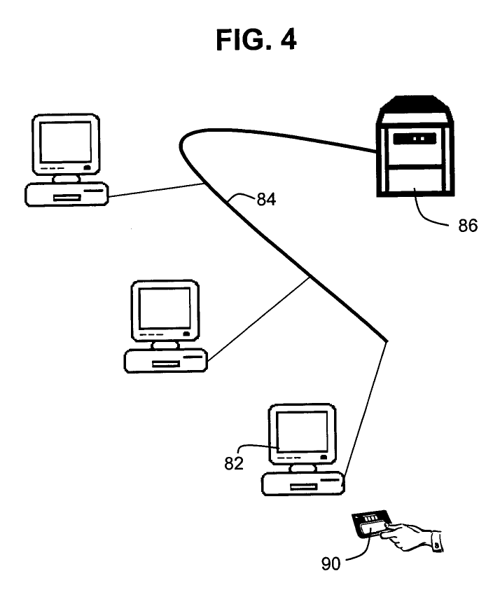

The invention can be embodied as a database server offering, or can be an application program, or both. Referring to FIG. 4, the user can operate a terminal 82 on a network 84 to operate the evolution so as to modify a database on server 86. Alternatively, the user can employ the technique to generate a subset or database copy on terminal 82 or on the server 86.

The invention concerns a series of steps undertaken to evolve a database from one schema to another in a safe, documented and organized way. The method preferably is carried out using a programmed data processor that can be operated at a server 86 or at an applications workstation 82. The invention is embodied in the programming of the processor that carries out the method as described, and the invention can be defined as a computer readable medium 90 encoded with computer-executable instructions for controlling operation of a processor to perform the stated method, shown figuratively as diskette 90 in FIG. 4.

The computer readable medium can take various forms and can be operated in various configurations of computer systems in which the processing steps are localized or distributed, but wherein the elements of the system as a whole undertake in coordination with one another and preferably with an operator to practice the described method. These elements include the programming that controls operation, which can be online or offline, e.g., contained in the database server processes available to users or separately made available to the processor(s) that employ all or parts of the programming. In this respect, the system and its one or more processors can be responsive to programming stored in a data carrier such as a semiconductor memory or on disk or CD or downloaded to a memory (e.g. volatile memory) from another source. The programming instructions that actually are executed by the processor can be complete as supplied, or can be generated as the output of another process associated with the printing device or associated processor, for example. They can exist as software program(s) comprised of program instructions in source code or object code, executable code or other formats, and can include hardware, firmware and combinations thereof.

Any of the above may be embodied on a computer readable medium, which include storage devices and signals, in compressed or uncompressed form. Exemplary computer readable storage devices include conventional computer system RAM (random access memory), ROM (read only memory), EPROM (erasable, programmable ROM), EEPROM (electrically erasable, programmable ROM), flash memory, and magnetic or optical disks or tapes. Exemplary computer readable signals, whether modulated using a carrier or not, are signals that a computer system hosting or running the computer program may be configured to access, including signals downloaded through the Internet or other networks. Examples of the foregoing include distribution of the program(s) on a CD ROM or via Internet download. The same is true of computer networks in general.

In terms of its method steps, the invention is a method for modifying a database structure, the database being defined at least partly by commands that define a database schema containing tables with fields that have attributes, the steps including providing a set of schema instructions defining a database structure according to a preexisting schema; providing a corresponding set of schema instructions defining the database according to a modified schema; parsing the schema instructions for both the preexisting schema and the modified schema, so as to produce two logical syntax trees wherein the database structure is defined by at least a subset of structure types and attributes of which at least one differs between the preexisting schema and the modified schema; comparing the two logical syntax trees to generate a set of differences between said structure types and attributes of the subset; and generating from the differences a set of database modification commands for altering a database according to the preexisting schema, to a database according to the modified schema, with respect to the structure types and attributes of the subset.

The invention is apt for evolving a database structure of a sort defined by an access and query language that defines tables of variables having labels and field characteristics, such as ANSI structured query language (SQL). The aspects of the database that are considered structures in this regard include, without limitation, association of variable values with a key variable; association of variable values in at least one table; table name and labeling; variable name and labeling; aliases; table type; variable type; table dimensions; field length; variable numeric format; variable string format; identification of key variables; conditions for uniqueness; conditions for null-ability; and, default values.

The eventual intended result is to evolve schema instructions defining the database structure of an existing operational database as determined by its schema instructions. The organized generation of schema changing instructions and the application of these instructions to evolve a database are a part of the invention. The invention further involves modifying the operational database by applying the database modification commands thereto. The commands needed to alter the database according to the old database schema, are preferably applied to such existing database to produce a new database conforming to the new schema.

An ambiguity can arise in the comparing of the logical syntax trees to generate the set of differences between said structure types and attributes of the subset. The ambiguity preferably is presented to the user for resolution. The system can offer choices and accept an input from the user for resolving the ambiguity by making such choice, whereupon the database modification commands are at least partly based on the input from the user. This process can produce a log file for recording differences, presenting ambiguities or choices to the user, and recording the user's choices for alternative structures or alternative steps for complying with the desired evolution. Examples of such choices include, for example, choices between renaming at least one of a table and a variable in a table, versus deleting and replacing at least one of said table and the variable in said table, and other similar such choice.

As a data carrier for programmed instructions or a programmed processor that carries out such instructions, alone or in conjunction with the user and with other processors, the invention comprises a computer readable medium encoded with computer-executable instructions for controlling operation of a processor of a printing device to cause the processor to perform the method steps, and/or a system that is thus programmed to perform the steps of modifying a database structure, the database being defined at least partly by commands that define a database schema containing tables with fields that have attributes, the steps being stated above.

The invention is not limited to the particular constructions herein disclosed and shown in the drawings, but also comprises any modifications or equivalents within the scope of the appended claims.

1. A method for modifying a database structure, the database being defined at least partly by commands that define a database schema containing tables with fields that have attributes, comprising the steps of:
providing a set of schema instructions defining a database structure according to a preexisting schema;
providing a corresponding set of schema instructions defining the database according to a modified schema;
parsing the schema instructions for both the preexisting schema and the modified schema, so as to produce two logical syntax trees wherein the database structure is defined by at least a subset of structure types and attributes of which at least one differs between the preexisting schema and the modified schema;
comparing the two logical syntax trees to generate a set of differences between said structure types and attributes of the subset;
generating from the differences a set of database modification commands for altering a database according to the preexisting schema, to a database according to the modified schema, with respect to the structure types and attributes of the subset.

2. The method according to claim 1, wherein the database structure is defined by an access and query language that defines tables of variables having labels and field characteristics.

3. The method of claim 2, wherein the database structure is defined by ANSI structured query language (SQL).

4. The method of claim 2, wherein the database structure is defined by at least one aspect selected from the group consisting of: association of variable values with a key variable; association of variable values in at least one table; table name and labeling; variable name and labeling; aliases; table type; variable type; table dimensions; field length; variable numeric format; variable string format; identification of key variables; conditions for uniqueness; conditions for null-ability; and, default values.

5. The method of claim 2, wherein the schema instructions defining the database structure according to the preexisting schema are derived from an operational database, and further comprising the step of modifying the operational database by applying the database modification commands thereto.

6. The method of claim 1, further comprising: identifying at least one ambiguity in said comparing of the two logical syntax trees to generate the set of differences between said structure types and attributes of the subset; presenting said ambiguity to a user for resolution; accepting an input from the user for resolving the ambiguity; and wherein said generating of the database modification commands is at least partly based on said input from the user.

7. The method of claim 6, wherein the set of differences are stored in a log file and wherein presenting the ambiguity comprises at least one of displaying and sending the log file to a user.

8. The method of claim 6, further comprising recording a log containing a representation of at least one of said differences and said input from the user.

9. The method of claim 6, wherein the ambiguity comprises a choice between one of at least two alternative database structures that comply with the modified schema.

10. The method of claim 6, wherein the ambiguity comprises a choice between one of at least two alternative modifications to the preexisting schema that proceed toward the modified schema.

11. The method of claim 10, wherein the ambiguity comprises a choice between renaming at least one of a table and a variable in a table, versus deleting and replacing at least one of said table and the variable in said table.

12. A computer readable medium encoded with computer-executable instructions for controlling operation of a processor of a printing device to cause the processor to perform a method comprising:
providing a set of schema instructions defining a database structure according to a preexisting schema;
providing a corresponding set of schema instructions defining the database according to a modified schema;
parsing the schema instructions for both the preexisting schema and the modified schema, so as to produce two logical syntax trees wherein the database structure is defined by at least a subset of structure types and attributes of which at least one differs between the preexisting schema and the modified schema;
comparing the two logical syntax trees to generate a set of differences between said structure types and attributes of the subset;
generating from the differences a set of database modification commands for altering a database according to the preexisting schema, to a database according to the modified schema, with respect to the structure types and attributes of the subset.

13. The computer readable medium according to claim 12, wherein the database structure is defined by an access and query language that defines tables of variables having labels and field characteristics, and the database structure is defined to include at least one aspect that is changeable with respect to one of: association of variable values with a key variable; association of variable values in at least one table; table name and labeling; variable name and labeling; aliases; table type; variable type; table dimensions; field length; variable numeric format; variable string format; identification of key variables; conditions for uniqueness; conditions for null-ability; and, default values.

14. A dataprocessing system for manipulating a database, comprising at least one programmed processor responsive to computer-executable instructions configured for:
providing a set of schema instructions defining a database structure according to a preexisting schema;
providing a corresponding set of schema instructions defining the database according to a modified schema;
parsing the schema instructions for both the preexisting schema and the modified schema, so as to produce two logical syntax trees wherein the database structure is defined by at least a subset of structure types and attributes of which at least one differs between the preexisting schema and the modified schema;
comparing the two logical syntax trees to generate a set of differences between said structure types and attributes of the subset;
generating from the differences a set of database modification commands for altering a database according to the preexisting schema, to a database according to the modified schema, with respect to the structure types and attributes of the subset.
